(19) United States
(12) Patent Application Publication
(10) Pub. No.: US 2021/0356423 A1
(43) Pub. Date: Nov. 18, 2021

(54) EXHAUST SENSOR

(71) Applicant: DENSO CORPORATION, Kariya-city (JP)

(72) Inventor: Tomotaka Mori, Kariya-city (JP)

(21) Appl. No.: 17/386,357

(22) Filed: Jul. 27, 2021

Related U.S. Application Data
(63) Continuation of application No. PCT/JP2020/000554, filed on Jan. 10, 2020.

(30) Foreign Application Priority Data
Jan. 28, 2019 (JP) 2019-012059

(51) Int. Cl. G01N 27/407; G01N 27/409

(52) U.S. Cl. CPC G01N 27/4077; G01N 27/409

(57) ABSTRACT

The sensor element of an exhaust sensor has a solid electrolyte body provided with a detection electrode exposed to a gas to be detected, and provided with a reference electrode. A porous protective layer is provided on the outer surface of the solid electrolyte body including the surface of the detection electrode. The porous protective layer is composed of a plurality of aggregate particles bonded to each other. When a plurality of crystal grains constituting an aggregate particle are observed in cross section, the number of crystal grain boundary intersections where three or more of the crystal grains intersect, per unit area, is in the range of 1 to 10,000/μm².

### CROSS-REFERENCE TO RELATED APPLICATION

The present application is a continuation application of International Application No. PCT/JP2020/000554 filed on Jan. 10, 2020, which is based on and claims the benefit of priority from Japanese Patent Application No. 2019-012059 filed on Jan. 28, 2019. The contents of these applications are incorporated herein by reference in their entirety.

### BACKGROUND

The present disclosure relates to an exhaust sensor for detecting a gas, with the exhaust gas from an internal combustion engine as the gas to be detected.

In an exhaust sensor that detects a gas, with the exhaust of an internal combustion engine as the gas to be detected, a sensor element is used in which a detection electrode and a reference electrode are provided on a solid electrolyte body. A porous protective layer that protects the sensor element from water is provided on the surface of the sensor element. The porous protective layer is formed of ceramic particles such as metal oxides.

### SUMMARY

One aspect of the present disclosure is an exhaust sensor that is provided with a sensor element, and wherein:

the sensor element comprises a solid electrolyte body, a detection electrode, and a reference electrode;

a porous protective layer is provided on at least one of a surface of the detection electrode and a path that guides the gas;

the porous protective layer is composed of a plurality of aggregate particles; and

when a plurality of crystal grains constituting an aggregate particle are observed in cross section, the number of crystal grain boundary intersections where three or more of the crystal grains intersect, per unit area, is in the range of 1 to 10,000/μm².

It should be noted that that the reference signs in parentheses of the components described for each aspect of the present disclosure indicate correspondence with the reference signs in the drawings of an embodiment, however each component is not limited to the contents of that embodiment.

### BRIEF DESCRIPTION OF THE DRAWINGS

The above objects and other objects, features and advantages of the present disclosure will be made clearer by the following detailed description, given referring to the appended drawings. In the drawings:

FIG. 1 is a cross sectional view of an exhaust sensor according to a first embodiment,

FIG. 2 is a partial expanded cross-sectional view of a sensor element of an exhaust sensor according to the first embodiment,

FIG. 3 is an explanatory diagram showing aggregate particles, constituting a porous protective layer according to the first embodiment, formed by a thermal spraying method.

FIG. 4 is a cross sectional view of a part of aggregate particles according to the first embodiment.

FIG. 5 is a cross sectional view showing another sensor element according to the first embodiment.

FIG. 6 is a graph showing the relationship between temperature and standard reaction Gibbs energy for various oxides, according to the first embodiment.

FIG. 7 is an explanatory diagram showing a measurement region for calculating the average value of the number of crystal grain boundary intersections in the aggregate particles of the porous protective layer according to the first embodiment.

FIG. 8 is a graph showing the relationship between the number of crystal grain boundary intersections in the aggregate particles and a water cracking number, according to the first embodiment.

FIG. 9 is an explanatory diagram illustrating the energy of stress due to thermal shock that is applied to the crystal grains of the aggregate particles, according to the first embodiment.

FIG. 10 is a flowchart of a method of producing aggregate particles by an electrofusion method, according to the first embodiment.

FIG. 11 is a flowchart of a method of producing aggregate particles by a sintering method, according to the first embodiment.

FIG. 12 is an explanatory diagram showing aggregate particles constituting a porous protective layer formed by a slurry coating method, according to the first embodiment.

FIG. 13 is a cross sectional view showing an exhaust sensor according to a second embodiment.

FIG. 14 is an enlarged cross-sectional view showing a part of a sensor element of the exhaust sensor according to the second embodiment.

FIG. 15 is an enlarged cross-sectional view taken along the line XV-XV in FIG. 14 showing part of the sensor element according to the second embodiment.

FIG. 16 is an enlarged cross-sectional view, equivalent to the view along line XV-XV of FIG. 14, showing part of another sensor element according to the second embodiment.

FIG. 17 is an enlarged cross sectional equivalent view, equivalent to the view along line XV-XV of FIG. 14, showing part of another sensor element according to the second embodiment.

### DETAILED DESCRIPTION OF THE PREFERRED EMBODIMENTS

A sensor element of the gas sensor of JP 2010-151575 A has a bottomed tubular solid electrolyte body, a measurement electrode provided on the outer peripheral surface of the solid electrolyte body, and a reference electrode provided on the inner peripheral surface of the solid electrolyte body, and a porous protective layer that covers the measurement electrode, while allowing the gas to be detected to pass through. The film thickness, porosity, etc., of the porous protective layer in the sensor element of JP 2010-151575 A are devised such as to ensure that the sensor element has water resistance.

In the case of a prior art gas sensor such as that of JP 2010-151575 A, the overall properties, characteristics, etc., of the porous protective layer are devised and improved by observing the porous protective layer externally However, no way has been devised for improving the water resistance to a required degree by observing the porous protective layer internally.

Specifically, the porous protective layer is composed of a plurality of aggregate particles such as ceramic. The assignees of the present invention have focused attention on the conditions of the plurality of crystal grains that constitute an aggregate particle, and have found that if the aggregate particles are made difficult to destroy from a microscopic aspect, the water resistance of the porous protective layer can be improved.

It is an objective of the present disclosure to provide an exhaust sensor having a porous protective layer with improved water resistance.

One aspect of the present disclosure is an exhaust sensor that is provided with a sensor element and performs gas detection using the exhaust gas of an internal combustion engine as the gas to be detected, and wherein:

the sensor element comprises a solid electrolyte body, a detection electrode provided on the solid electrolyte body and exposed to the gas to be detected, and a reference electrode provided on the solid electrolyte body;

a porous protective layer is provided on at least one of a surface of the detection electrode and a path that guides the gas to be detected to the surface of the detection electrode;

the porous protective layer is composed of a plurality of aggregate particles that are bonded directly or via an inorganic binder; and

when a plurality of crystal grains constituting an aggregate particle are observed in cross section, the number of crystal grain boundary intersections where three or more of the crystal grains intersect, per unit area, is in the range of 1 to 10,000/μm².

In the exhaust sensor according to the above aspect, the porous protective layer provided in the sensor element is observed from a microscopic aspect, and measures are taken to increase the strength of the aggregate particles constituting the porous protective layer. Specifically, focusing attention on the state of the plurality of crystal grains constituting an aggregate particle, the number of crystal grain boundary intersections between three or more crystal grains, per unit area, is held within the range of 1 to 10,000/μm².

The crystal grain boundary intersections are points at which three or more crystal grains are observed to intersect, when the crystal grain boundaries where the crystal grains meet are observed in a cross section of the porous protective layer. It can be considered that when stress energy such as thermal shock is applied to the porous protective layer, the stress energy is transmitted along crystal grain boundaries of the crystal grains constituting the aggregate particles. It can be considered that when the stress energy then passes through the corresponding crystal grain boundary intersections, the energy becomes attenuated by being dispersed among a plurality of crystal grain boundaries.

If the number of crystal grain boundary intersections per unit area is appropriate, being in the range of 1 to 10,000/μm², then the energy can be effectively dispersed when stress such as thermal shock is applied to the aggregate particles. As a result, the strength of the aggregate particles constituting the porous protective layer can be increased, and hence the water resistance of the porous protective layer can be improved.

Thus, the water resistance of the porous protective layer in the exhaust sensor according to the above aspect can be improved.

Preferred embodiments of the above exhaust sensor will be described referring to the drawings.

### First Embodiment

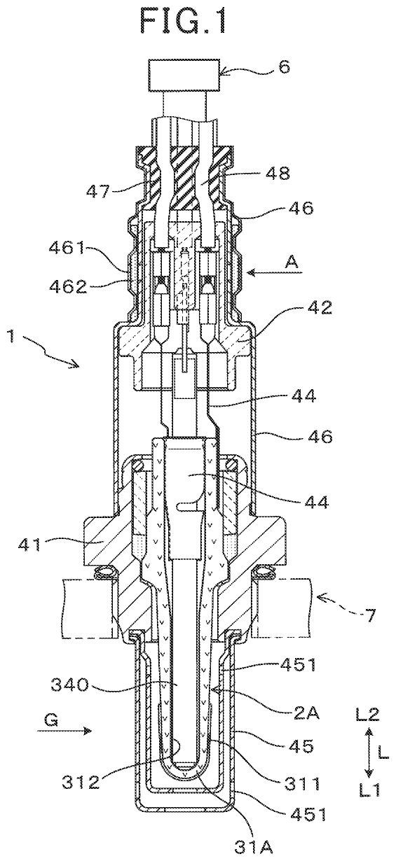

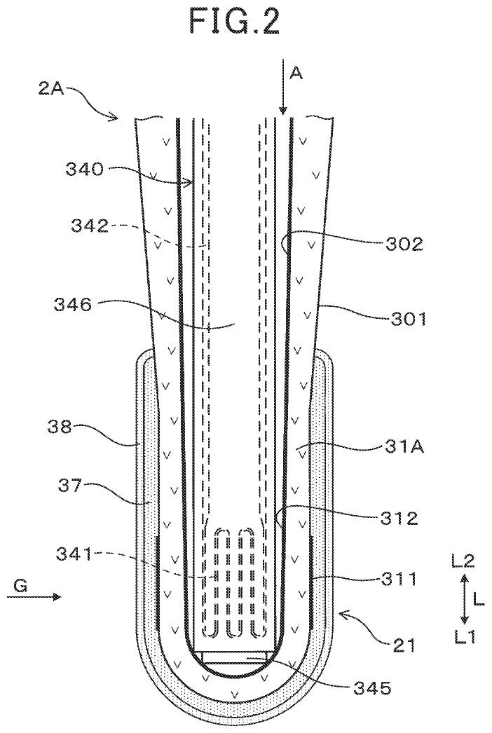

As shown in FIGS. 1 and 2, the exhaust sensor 1 of this embodiment includes a sensor element 2A, and performs gas detection using the exhaust gas of an internal combustion engine as the gas G to be detected. The sensor element 2A has a solid electrolyte body 31A, a detection electrode 311 provided on the solid electrolyte body 31A and exposed to the gas G to be detected, and a reference electrode 312 provided on the solid electrolyte body 31A. A porous protective layer 37 is provided on the outer surface 301 of the solid electrolyte body 31A, including the surface of the detection electrode 311.

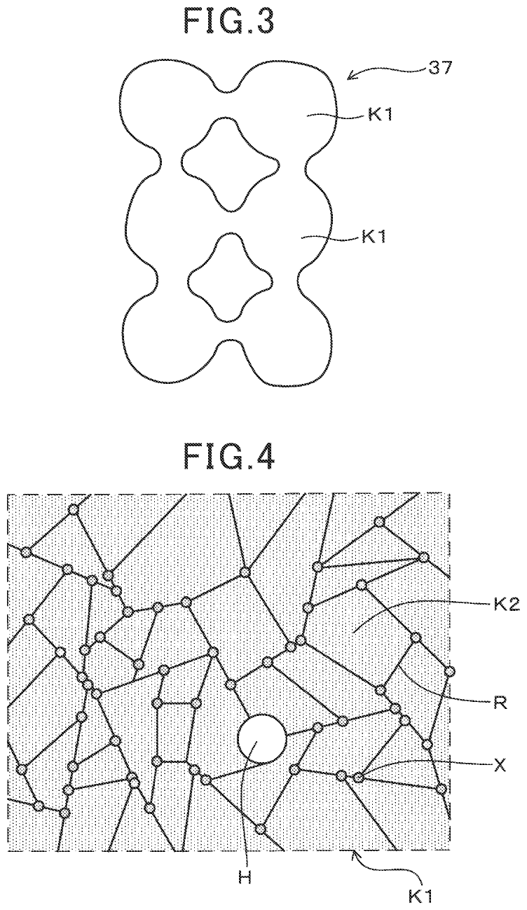

As shown in FIG. 3, the porous protective layer 37 is composed of a plurality of aggregate particles K1 bonded to each other. When a plurality of crystal grains K2 constituting an aggregate particle K1 are observed in cross sectional view as shown in FIG. 4, the number of crystal grain boundary intersections X at which three or more crystal grains K2 intersect per unit area is in the range of 1 to 10,000/μm².

The exhaust sensor 1 of this embodiment is described in detail in the following.

### (Exhaust Sensor 1)

As shown in FIG. 1, the exhaust sensor 1 of this embodiment is disposed for use in an exhaust pipe 7 through which exhaust gas is discharged from an internal combustion engine of an automobile. The exhaust sensor 1 is also referred to as a gas sensor. The exhaust sensor 1 detects the oxygen concentration in the gas G to be detected. The exhaust sensor 1 may determine whether the air-fuel ratio of the internal combustion engine obtained from the composition of the gas G to be detected is on the fuel rich side or the fuel lean side with respect to the stoichiometric air-fuel ratio. Furthermore, the exhaust sensor 1 may quantitatively derive the air-fuel ratio (A/F) of the engine, from the composition of the gas G to be detected. Moreover, the exhaust sensor 1 may detect the concentration of a specific gas component such as NOx (nitrogen oxide) in the gas G to be detected.

A catalyst for purifying harmful substances in the exhaust gas is disposed in the exhaust pipe 7, and the exhaust sensor 1 can be located on either the upstream side or the downstream side of the catalyst, with respect to the flow direction of the exhaust gas in the exhaust pipe 7. The exhaust sensor 1 can also be disposed in a pipe at the intake side of a supercharger that uses exhaust gas to increase the density of air drawn in by the internal combustion engine. Furthermore, the exhaust sensor 1 may be disposed in the intake pipe of an exhaust recirculation mechanism which recirculates part of the exhaust gas from the internal combustion engine that is discharged to the exhaust pipe 7, with the recirculated exhaust gas being passed into the intake manifold of the internal combustion engine.

### (Sensor Element 2A)

As shown in FIG. 2, the solid electrolyte body 31A of this embodiment has a bottomed cylindrical shape, and the sensor element 2A is of cup type. The solid electrolyte body 31A is conductive to oxygen ions (O²⁻) when in a prescribed activation temperature. A detection electrode 311 is provided on the outer surface 301 of the solid electrolyte body 31A, exposed to the gas G to be detected, and a reference electrode 312 is provided on the inner surface 302 of the solid electrolyte body 31A, exposed to a reference gas. The reference gas is atmospheric air or the like, which is taken into the exhaust sensor 1. The detection electrode 311 may be provided not only on the outer surface (outer peripheral surface) 301 of the cylindrical portion of the solid electrolyte body 31A, but also on the outer surface 301 of the bottom portion of the solid electrolyte body 31A. The reference electrode 312 may be provided not only on the inner surface (inner peripheral surface) 302 of the cylindrical portion of the solid electrolyte body 31A, but also on the inner surface 302 of the bottom portion of the solid electrolyte body 31A.

As shown in FIGS. 1 and 2, the detection electrode 311 and the reference electrode 312 are disposed facing one other via the solid electrolyte body 31A, at a part of the sensor element 2A which is at the tip end L1 in the longitudinal direction L. A detection unit 21 composed of the detection electrode 311, the reference electrode 312, and a portion of the solid electrolyte body 31A sandwiched between these electrodes 311, 312, is formed by a portion of the sensor element 2A at the tip end L1 in the longitudinal direction L. The portion of the sensor element 2A at the base end L2, in the longitudinal direction L, is retained by the housing 41 of the exhaust sensor 1.

The solid electrolyte 31A consists of a zirconia-based oxide containing zirconia as the main component (50% by mass or more), formed of stabilized zirconia or partially stabilized zirconia in which part of the zirconia is replaced by a rare earth metal element or by an alkaline earth metal element. Part of the zirconia for constituting the solid electrolyte body 31A can be replaced by yttria, scandia or calcia.

The detection electrode 311 and the reference electrode 312 contain platinum as a noble metal exhibiting catalytic activity for oxygen, and zirconia oxide which functions as a co-material with the solid electrolyte body 31A. The co-material serves to maintain the bonding strength of the detection electrode 311 and the reference electrode 312, when these are printed (coated) as a paste-like electrode material on the solid electrolyte body 31A and fired.

Electrode lead portions are connected to the detection electrode 311 and the reference electrode 312, for electrically connecting these electrodes to the exterior of the exhaust sensor 1. The electrode lead portions extend, in the longitudinal direction L, to the part of the sensor element 2A at the base end L2.

### (Porous Protective Layer 37)

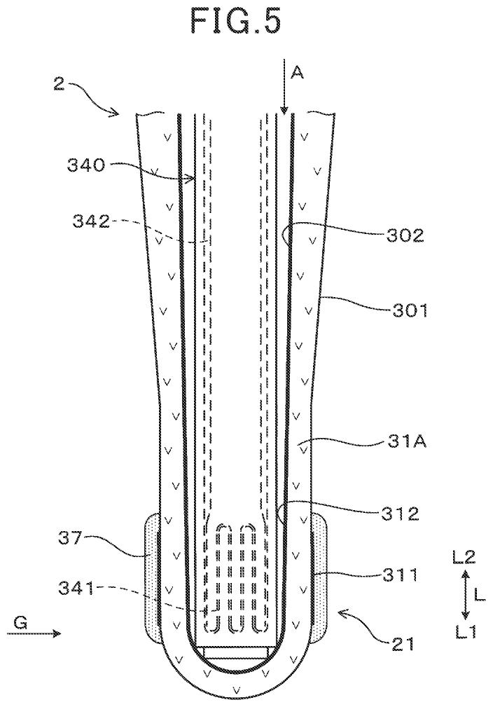

As shown in FIG. 2, a porous protective layer 37 is provided on the outer surface 301 of the solid electrolyte body 31A, including the surface of the detection electrode 311. The porous protective layer 37 is provided on a portion of the solid electrolyte body 31A at the tip end L1 in the longitudinal direction L. The porous protective layer 37 may be disposed extending continuously to the outer surface 301 of the bottom of the solid electrolyte body 31A. Alternatively as shown in FIG. 5, the porous protective layer 37 may be disposed only at a position corresponding to the position where the detection electrode 311 is provided on the outer surface 301 of the cylindrical portion of the solid electrolyte body 31A.

Another porous protective layer 38, that uses conventional aggregate particles in which the number of crystal grain boundary intersections X per unit area is less than 1/μm², may be provided on the surface of the porous protective layer 37, as shown by the other layer 38 in FIG. 2. Further, another porous protective layer 38 may be provided on the outer surface 301 of the solid electrolyte body 31A and the porous protective layer 37 may be provided on the surface of the other porous protective layer 38.

The porous protective layer 37 can be formed on the outer surface 301 of the solid electrolyte body 31A and the surface of the detection electrode 311 with a thickness in the range of 10 to 1000 μm. If the porous protective layer 37 is formed as a plurality of layers, the total thickness of the plurality of porous protective layers 37 can be set in the range of 10 to 1000 μm. If it is desired to increase the response speed of the exhaust sensor 1, the thickness of the porous protective layer 37 and of the other porous protective layer 38 can be made as small as possible.

The porous protective layer 37 can be provided in various forms. For example, a porous protective layer 37 may be formed on the outer surface 301 of the solid electrolyte body 31A by a thermal spraying method, then a porous protective layer 37 may be formed by the slurry coating method on the surface of the porous protective layer 37 which was formed by the thermal spraying method. Each of these porous protective layers 37 can be formed by using aggregate particles K1 in which the number of crystal grain boundary intersections X per unit area is in the range of 1 to 10,000/μm². Furthermore, both the porous protective layer 37 that is formed by the thermal spraying method, and the porous protective layer 37 that is formed by the slurry coating method, can be formed by stacking a plurality of layers.

### (Heater 340)

As shown in FIG. 2, a heater 340 for heating the solid electrolyte body 31A is disposed on the inner peripheral side of the solid electrolyte body 31A. The heater 340 is formed by a ceramic substrate 345 and a heating element sheet 346 that is wound around the ceramic substrate 345 and generates heat by energization. The heating element sheet 346 is formed with a heating generating portion 341 having a meandering configuration, and lead portions 342 connected to the heating generating portion 341. The sensor element 2A is heated by the heater 340 to bring the solid electrolyte body 31A and the pair of electrodes 311, 312 to the activation temperature.

### (Other Configuration Components of Exhaust Sensor 1)

As shown in FIG. 1, in addition to the sensor element 2A, the exhaust sensor 1 includes a housing 41 that retains the sensor element 2A, contact terminals 44 that contact the sensor element 2A, and an insulator 42 that retains the contact terminals 44. The exhaust sensor 1 is provided with a tip end cover 45 that covers the portion of the sensor element 2A at the tip end L1, and that is mounted on the portion of the housing 41 at the tip end L1, an insulator 42 that is mounted on the portion of the housing 41 at the base end L2, a base end cover 46 which covers the contact terminals 44, etc., a bushing 47 for retaining, in the base end cover 46, lead wires 48 that are connected to the contact terminals 44, etc.

The parts of the sensor element 2A and the tip end cover 45 that are located at the tip end L1 are disposed within the exhaust pipe 7 of the internal combustion engine. The tip end cover 45 is formed with a gas passage hole 451 for passing the exhaust gas, as the gas G to be detected. The tip end cover 45 may have a double structure or a single structure. The exhaust gas, flowing as the gas G to be detected into the tip end cover 45 from the gas passage hole 451 of the tip end cover, is guided to the detection electrode 311 on the outer peripheral side of the solid electrolyte body 31A by passing through the porous protective layer 37 of the sensor element 2A.

The base end cover 46 is disposed outside the exhaust pipe 7 of the internal combustion engine. The base end cover 46 is formed with a reference gas introduction hole 461 through which atmospheric air A is introduced into the base end cover 46. A filter 462, which does not allow liquid to pass through but allows passage of a gas, is disposed in the reference gas introduction hole 461. Atmospheric air A that is introduced into the base end cover 46 from the reference gas introduction hole 461 passes through a gap in the base end cover 46 and is guided to the reference electrode 312 on the inner peripheral side of the solid electrolyte body 31A.

The plurality of contact terminals 44 are disposed on the insulator 42, connected to the electrode lead portions of the detection electrode 311 and the reference electrode 312, and to the lead portions 342 of the heating element sheet 346 of the heater 340. Lead wires 48 are respectively connected to the contact terminals 44.

As shown in FIG. 1, the lead wires 48 in the exhaust sensor are electrically connected to a sensor control device 6 that controls gas detection by the exhaust sensor 1. The sensor control device 6 performs electrical control in the exhaust sensor 1 in cooperation with an engine control apparatus that controls combustion operation in the engine. The sensor control device 6 includes a measurement circuit or the like, for measuring the electromotive force generated between the detection electrode 311 and the reference electrode 312.

The sensor control device 6 may be built into the engine control apparatus. Furthermore, depending on the configuration of the exhaust sensor 1, the sensor control device 6 may include a measurement circuit for measuring the current flowing between the detection electrode 311 and the reference electrode 312, a voltage application circuit for applying a voltage between the detection electrode 311 and the reference electrode 312, etc.

### (Aggregate Particles K1)

The aggregate particles K1 constituting the porous protective layer 37 are composed of metal oxides as illustrated in FIG. 3, which have a high melting point and may be exposed to exhaust gas at a temperature of the order of 1000° C. Carbon (C) is present in the exhaust gas, constituted by fuel components exhausted from the internal combustion engine. If the metal oxides constituting the aggregate particles K1 are more easily reduced than carbon, there is a danger that the metal oxides will be reduced before the oxides of carbon are reduced, and may become metallized. In that case, the aggregate particles K1 readily become cracked.

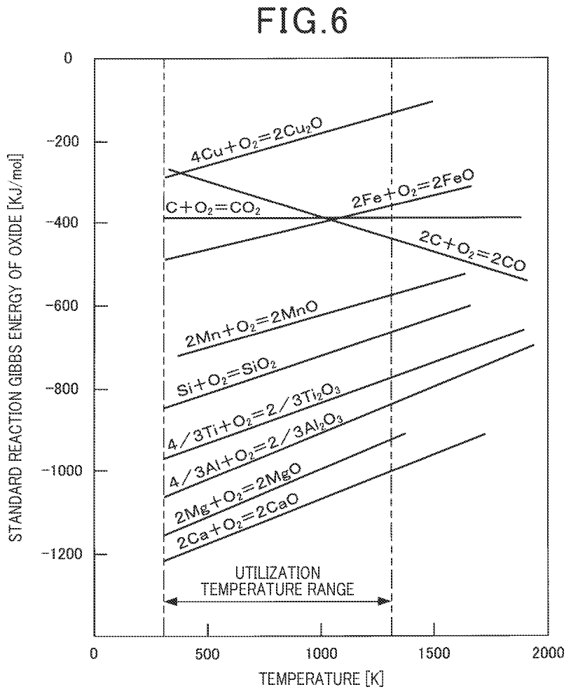

FIG. 6 shows the relationship between temperature and standard reaction Gibbs energy for various oxides. A range of 300 to 1300° C. is set as the operating temperature range of the exhaust sensor 1, and values of standard reaction Gibbs energy within this operating temperature range are compared. The standard reaction Gibbs energy indicates the energy required for producing and maintaining an oxide, and the lower the standard reaction Gibbs energy (that is, the greater on the negative side), the more difficult it is for the oxide to be reduced. The standard reaction Gibbs energy of oxides such as oxides of copper (Cu) and iron (Fe) is higher (smaller on the negative side) than the standard reaction Gibbs energy of oxides of carbon (C). Hence, it can be said that oxides such as those of copper and iron have the property of being easily reduced in the usage environment of the exhaust sensor 1.

The aggregate particles K1 constituting the porous protective layer 37 are preferably composed of a metal oxide having a standard reaction Gibbs energy lower than that of oxides of carbon (higher on the negative side). The metal oxide is thereby less likely to be reduced, in the usage environment of the exhaust sensor 1, and the state of the metal oxide is easily maintained (the metal oxide is likely to exist in a stable condition). Hence the strength of the aggregate particles K1 constituting the porous protective layer 37 can be maintained at a high level.

The standard reaction Gibbs energy of oxides such as those of aluminium (Al) and magnesium (Mg) is lower (higher on the negative side) than that of carbon (C) oxides. Hence it can be said that oxides such as of aluminium and magnesium have the property of not being readily reduced, in the usage environment of the exhaust sensor 1.

Furthermore, other than oxides such as those of aluminium and magnesium, oxides such as those of silicon (Si), titanium (Ti) and calcium (Ca) may be used for the aggregate particles K1. The aggregate particles K1 can be composed of spinel (MgAl₂O₄), alumina (Al₂O₃, aluminium oxide), magnesia (MgO, magnesium oxide), silica (SiO₂), silicon dioxide), titania (TiO₂, titanium oxide), calcia (CaO, calcium oxide), etc,

### (Crystal Grain Boundary Intersections X)

The crystal grain boundary intersections X, illustrated in FIG. 4, are observed in a sliced cross section of the aggregate particles K1 in the porous protective layer 37, using a microscope or the like. When observed in cross section, the aggregate particles K1 are in a state in which a large number of crystal grains K2 are joined to each other. The crystal grains K2 are bonded to each other via crystal grain boundaries R, and each point at which the crystal grain boundaries R of three or more crystal grains K2 intersect is observed as a crystal grain boundary intersection X. There are crystal grain boundary intersections X which are points where the crystal grain boundaries R of three crystal grains K2 intersect, intersections X which are points where the crystal grain boundaries R of four crystal grains K2 intersect, and intersections X which are points where the crystal grain boundaries R of five or more crystal grains K2 intersect.

It can be considered that amorphous (non-crystalline) material, which is a state of matter having no crystalline structure, and impurities that are different from the metal oxides constituting the aggregate particles K1, etc., are present at the crystal grain boundary intersections X. Due to the presence of these amorphous substances, impurities, etc., the strength at the crystal grain boundary intersections X is lower than that inside the crystal grains K2.

Furthermore, as observed in cross section, there are parts of the aggregate particles K1 where pores H (including cavities, voids, etc.,) are adjacent to the crystal grains K2. Points where the crystal grain boundaries R of two or more crystal grains K2 intersect, but which are sited adjacent to a pore H, are not included in the crystal grain boundary intersections X. Amorphous substances, impurities, etc., are not present in the vicinity of an intersection where crystal grain boundaries R intersect but which is close to the site of a pore H. Hence when stress such as thermal shock is applied to the aggregate particles K1, the stress energy is not dispersed at those intersections where crystal grain boundaries R intersects and where are at parts adjacent to pores H. For that reason, when an intersection between crystal grain boundaries R is located adjacent to a pore H, it is not included in the number of crystal grain boundary intersections X.

### (Method of Measuring the Number of Crystal Grain Boundary Intersections X)

The number of crystal grain boundary intersections X in the aggregate particles K1 can be measured by observing a sliced cross section of the aggregate particles K, using a SEM (scanning electron microscope). The aggregate particles K1 are produced by melting a metal oxide, as the raw material, before forming the porous protective layer 37 with a predetermined particle size. The entire porous protective layer 37 is formed collectively with respect to the sensor element 2A. It can thus be considered that the state of formation of the crystal grains K2 in the aggregate particles K1 is the same at any part of the porous protective layer 37.

The number of crystal grain boundary intersections X in the aggregate particles K1 of the porous protective layer 37 can be taken to be the average value of the respective numbers of crystal grain boundary intersections X that are present at a plurality of locations in the porous protective layer 37. A measurement region for measuring the number of crystal grain boundary intersections X at a location can be, for example, an area of 4 μm in the longitudinal direction L by 5 μm in the direction orthogonal to the longitudinal direction L, on the surface of the porous protective layer 37. The number of crystal grain boundary intersections X in this measurement region can be measured, and the number of crystal grain boundary intersections X per 1 μm², as a unit area, can be calculated from this number.

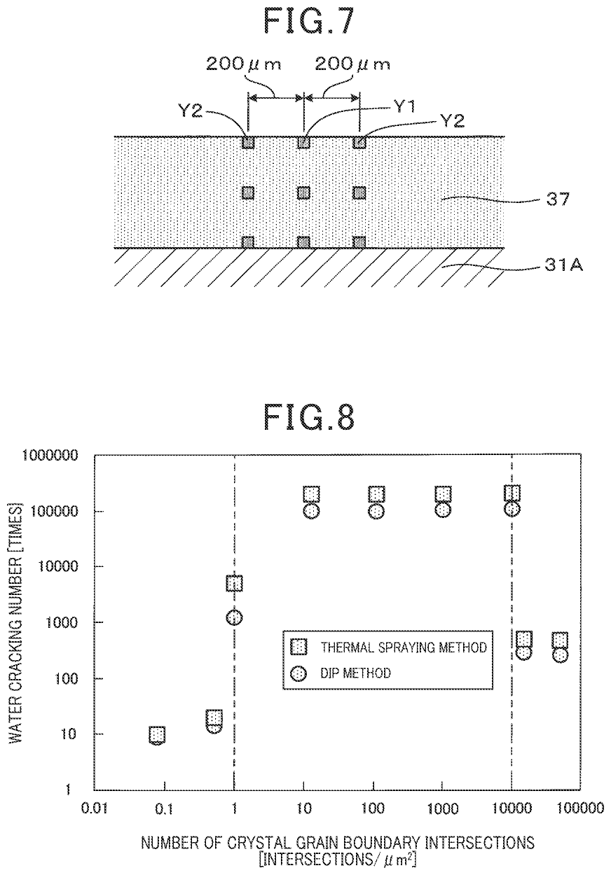

As shown in FIG. 7, the measurement regions for calculating the average value of the number of crystal grain boundary intersections X can be determined using various patterns. For example, a measurement region having an area of 4 μm×5 μm that is on the surface of the porous protective layer 37 and that reaches the maximum temperature can be specified as a maximum temperature measurement region Y1, while adjacent measurement regions which have areas of 4 μm×5 μm and that are spaced apart by equal center distances of 200 micron from the maximum temperature measurement region Y1 in the longitudinal direction L, at the tip-end side and the base-end side respectively of the maximum temperature measurement region Y1, are specified as adjacent measurement regions Y2. The number of crystal grain boundary intersections X per 1 μm² is then calculated for the maximum temperature measurement region Y1 and for each of the two adjacent measurement regions Y2, and the average value of the number of crystal grain boundary intersections X per 1 μm² in the maximum temperature measurement region Y1 and the two adjacent measurement regions Y2 can then be calculated.

It is also possible to determine the measurement regions used for calculating the average value of the number of crystal grain boundary intersections X based on consideration of differences between numbers of crystal grain boundary intersections X in the thickness direction of the porous protective layer 37. For example, the number of crystal grain boundary intersections X per 1 μm² can be calculated for a measurement region having an area of 4 μm×5 μm on the outermost surface of the porous protective layer 37 in the thickness direction, for a measurement region having an area of 4 μm×5 μm on the innermost surface of the porous protective layer 37 in the thickness direction, and for a measurement area of 4 μm×5 μm at an intermediate position in the thickness direction of the porous protective layer 37, then the average value of the number of crystal grain boundary intersections per 1 μm² in these three measurement regions can be calculated.

Furthermore, the average value of the number of crystal grain boundary intersections X per 1 μm² can be calculated for nine measurement regions that overlap in the thickness direction, consisting of a maximum temperature measurement region Y1 and two adjacent measurement regions Y2 on the outermost surface of the porous protective layer 37, a maximum temperature measurement region Y1 and two adjacent measurement regions Y2 on the innermost surface of the porous protective layer 37, and a maximum temperature measurement region Y1 and two adjacent measurement regions Y2 at an intermediate position in the thickness direction of the porous protective layer 37.

If there are pores H in a measurement region that is used in obtaining the average number of crystal grain boundary intersections X, the average number is calculated using the area obtained by subtracting the area of the pores H from the area of that measurement region.

### (Number of Crystal Grain Boundary Intersections X)

As shown in FIG. 4, the number of crystal grain boundary intersections X where three or more crystal grains K2 intersect in an aggregate particle K1 is related to the size of the crystal grains K2 in the aggregate particle. As the size of the crystal grains K2 in the aggregate particles K1 becomes smaller, the number of crystal grain boundary intersections X tends to increase. The number of crystal grains K2 in the aggregate particles K1 is preferably in the range of 1 to 10,000/μm².

The appropriate number of crystal grain boundary intersections X where three or more crystal grains K2 intersect was determined based on the result of examining the water resistance (water cracking number [times]) of the porous protective layer 37. The water resistance was obtained by a computer simulation in which 1 μL water droplets were dropped vertically on the porous protective layer 37 provided on the sensor element 2A, to find the number of times the water droplets were dropped until cracking of the porous protective layer 37 occurred. The greater the number of times the water droplets dropped before cracking occurs, the higher was the water resistance. The temperature of the sensor element 2A when examining the water resistance was 500° C., and the thickness of the porous protective layer 37 was 100 μm. The position at which the 1 μL water droplets were dropped vertically was that of a maximum temperature measurement region Y1 on the surface of the porous protective layer 37.

FIG. 8 shows the relationship between the number of crystal grain boundary intersections X in the aggregate particles K1 [intersections/μm²] and the water cracking number. Values of the number of crystal grain boundary intersections X are shown along the horizontal axis and values of the water cracking number along the vertical axis, using a logarithmic scale. The water resistance results are shown for the case where the porous protective layer 37 is formed by the thermal spraying method and the case where the porous protective layer 37 is formed by the dip method (slurry coating method). As a whole, the porous protective layer 37 formed by the thermal spraying method provides a higher water resistance than that formed by the dip method.

It was found that if the number of crystal grain boundary intersections X is 1/μm², the water resistance is 1,000 times or more, regardless of whether the thermal spraying method or the dip method is used, so that sufficient water resistance can be obtained. On the other hand, it was found that if the number of crystal grain boundary intersections X per unit area is less than 1/μm², the water resistance is about 10 times, irrespective of whether the thermal spraying method or the dip method is used, so that sufficient water resistance cannot be obtained.

Further it was found that the highest water resistance, of about 100,000 times, is obtained when the number of crystal grain boundary intersections X per unit area is in the range of 10 to 10,000/μm², irrespective of whether the thermal spraying method or the dip method is used. This result shows that the number of crystal grain boundary intersections X per unit area in the aggregate particles K1 is preferably in the range of 1 to 10,000/μm², and more preferably in the range of 10 to 10,000/μm².

It was also found that if the number of crystal grain boundary intersections X exceeds 10,000/μm², the water resistance decreases. It is thought that in that case, the crystal grains K2 in the aggregate particles K1 become excessively small, and the influence of strain between the aggregate particles K1 increases, so that residual stress in the particles increases and the aggregate particles K1 are thereby weakened.

### (Mechanism of Stress Absorption in Aggregate Particles K1)

As shown in FIG. 1, when the exhaust sensor 1 is disposed in the exhaust pipe 7 and used, the exhaust gas flowing through the exhaust pipe 7 flows into the tip end cover 45 through the gas passage hole 451 of the tip end cover 45. The exhaust gas then comes into contact with the porous protective layer 37 provided in the sensor element 2A, and toxic substances, water droplets, etc., contained in the exhaust gas are captured by the porous protective layer 37. Here, “poisonous substance” refers to a substance that may adhere to the detection electrode 311 and poison (cause deterioration of) the detection electrode 311. Toxic substances contained in the exhaust gas can include Si (silicon), S (sulfur), Pb (lead), glass components, soot formed of fine carbon particles generated by incomplete combustion of organic substances produced in the internal combustion engine, etc. Some of the water droplets consist of moisture that condenses when the exhaust gas in the exhaust pipe 7 cools, and subsequently becomes scattered by the exhaust gas.

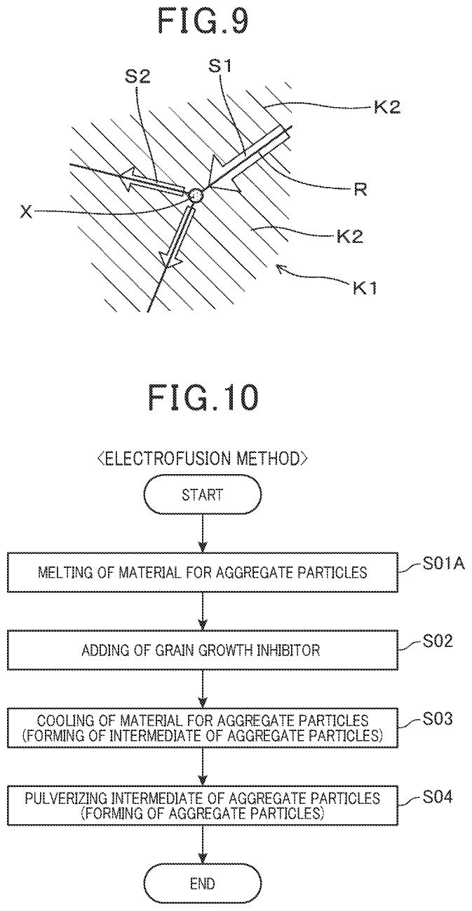

If water droplets come into contact with the porous protective layer 37 when the aggregate particles K1 constituting the porous protective layer 37 have become raised to a high temperature, in the region of 500 to 700° C. for example, then stress due to thermal shock is applied, as illustrated in FIG. 9. It is considered that when this occurs, stress energy is transmitted along the crystal grain boundaries R of the plurality of crystal grains K2 constituting an aggregate particle K1 in the plurality of aggregate particles K1. The energy is transmitted along the crystal grain boundaries R between each of respective pairs of adjacent crystal grains K2, after passing through a crystal grain boundary intersection X which is the intersection between the pair of adjacent crystal grains K2 and another crystal grain K2.

At this time, the energy becomes dispersed, and transmitted to a plurality of crystal grain boundaries R at respective crystal grain boundary intersections X. FIG. 9 illustrates a state in which energy S1 that has been transmitted along a crystal grain boundary R is dispersed between a plurality of energy amounts S2 at a crystal grain boundary intersection X, which are then transmitted along a plurality of other crystal grain boundaries R. As a result, energy is attenuated by passing through a crystal grain boundary intersection X, and it is considered that the higher the number of crystal grain boundary intersections X per unit area in the aggregate particles K1, the greater becomes the degree of energy attenuation.

### (Method of Manufacturing Aggregate Particles K1)

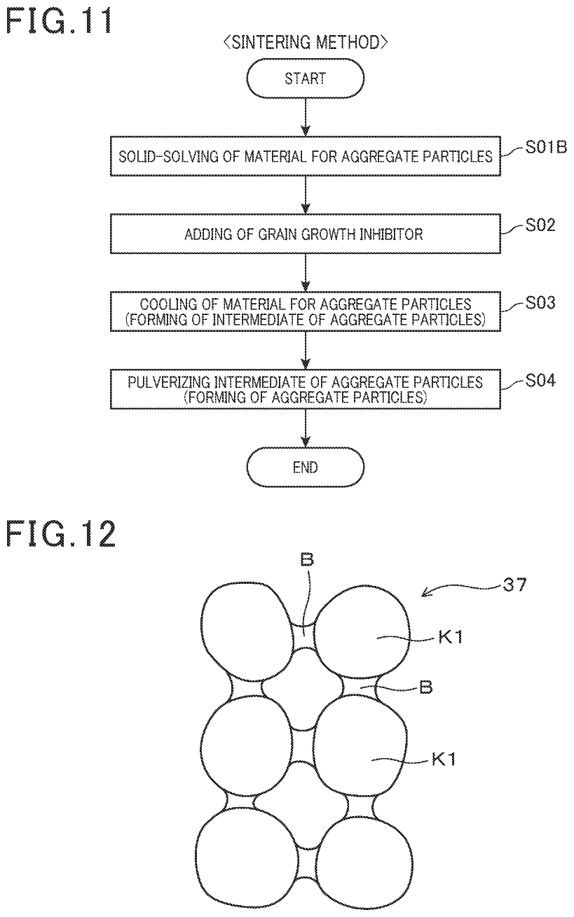

The aggregate particles K1 that form the porous protective layer 37 of this embodiment are produced as a metal oxide, a spinel (MgAl₂O₄), which is an oxide of aluminium and magnesium. The aggregate particles K1 can be produced by an electrofusion method or a sintering method. The method of producing the aggregate particles K1 by the electrofusion method is shown in the flowchart of FIG. 10, and the method of producing the aggregate particles K1 by the sintering method is shown in the flowchart of FIG. 11.

### (Electrofusion Method)

When the aggregate particles K1 are produced by the electrofusion method, aluminium and magnesium are heated, as materials for the aggregate particles, at 2500° C. for 0.5 hour in an electric furnace (step S01A in FIG. 10). A grain growth inhibitor such as ZnO (zinc oxide): 0.01 to 5% by mass, can be added at this time to the total amount of the aggregate particle material: 100% by mass (step S02 in FIG. 10). The grain growth inhibitor then becomes mixed with the dissolved aluminium and magnesium. By adding the grain growth inhibitor it becomes possible to adjust the size of the crystal grains K2 and the number of crystal grain boundary intersections X per unit area, in the aggregate particles K1 that are produced.

As the proportion of added grain growth inhibitor is increased, the crystal grains K2 in the aggregate particles K1 become smaller, and the number of crystal grain boundary intersections X per unit area in the aggregate particles K1 increases. If the proportion of added grain growth inhibitor is less than 0.01% by mass, then the grain growth inhibitory effect may be insufficient, and the number of crystal grain boundary intersections X per unit area in the aggregate particles K1 may be less than necessary. On the other hand, if the proportion of the added grain growth inhibitor exceeds 5% by mass, the grain growth inhibitory effect may become excessive, and the number of crystal grain boundary intersections X per unit area of the aggregate particles K1 may be greater than necessary.

In order to set the number of crystal grain boundary intersections X per unit area in the range of 1 to 10,000/μm², the aggregate particles K1 preferably contain grain growth inhibitor: 0.01-5% to metal oxide: 100% by mass. The grain growth inhibitor may be present alone in the aggregate particles K1, separate from the metal oxide, or may be present in a state of being combined with or mixed with the metal oxide. It would be equally possible to use a growth inhibitor other than ZnO.

When a predetermined time has elapsed after the material for the aggregate particles is melted, the material becomes cooled and solidified, forming intermediates of the aggregate particles K1 (step S03 in FIG. 10). At this time, the number of crystal grain boundary intersections X per unit area of the aggregate particles K1 can be adjusted by appropriately adjusting the cooling rate of the material for the aggregate particles. Specifically, the rate of cooling the melted aggregate particle material can be in the range of 10° C./min to 1000° C./sec.

Possible methods that can be used to cool the material for the aggregate particles include simply leaving the material to cool, or blowing air, water cooling, etc. Blowing air or water cooling can be performed if it is required to increase the cooling rate.

If the cooling rate is less than 10° C./min, the surface energy of the crystal grain boundary component of the crystal grains K2 in the aggregate particles K1 becomes small, and aggregation causes the crystal grains K2 to increase in size. The number of crystal grain boundary intersections X per unit area of the aggregate particles K1 may thus be smaller than the required number. On the other hand, if the cooling rate exceeds 1000° C./sec, progression of the grain growth of the crystal grains K2 in the aggregate particles K1 becomes excessively slow. The number of crystal grain boundary intersections X per unit area of the aggregate particles K1 may thus be larger than the required number.

It is preferable for the cooling rate of the melted aggregate particle material to be in the range of 10° C./min to 1000° C./sec, in order to set the number of crystal grain boundary intersections X per unit area in the range of 1 to 10,000/μm²,

### (Sintering Method)

When aggregate particles K1 are produced by the sintering method, alumina and magnesia, as the materials for the aggregate particles, are mixed, kneaded and dried, and the mixture of alumina and magnesia is then heated to 1000 to 1600° C. and sintered. At this time, the alumina and magnesia become dissolved in a state of a solid solution to form spinel (step S01B in FIG. 11). The alumina and magnesia can be either in the form of a dense body or a porous body, depending on the degree of gas permeability required for the porous protective layer 37.

In the sintering method as well, as in the electrofusion method, the entire amounts of alumina and magnesia as materials for aggregate particles: 100% by mass, and of the grain growth inhibitor such as ZnO (zinc oxide): 0.01 to 5% by mass, can be added (step S02 in FIG. 11). The action and effect in that case are the same as in the case of the electrofusion method. In the sintering method, as in the electrofusion method, the mixture of alumina and magnesia is cooled to form intermediates of the aggregate particles K1 (step S03 in FIG. 11).

Furthermore, in the sintering method, the heating rate (temperature increase rate) of the mixture of alumina and magnesia when sintering the mixture, and the cooling rate (temperature decrease rate) for cooling the mixture of alumina and magnesia after heating, can be set in the range of 10° C./min to 1000° C./sec. The problems that occur when the heating rate and the cooling rate are less than 10° C./min or exceed 1000° C./sec are the same as in the case of the electrofusion method.

### (Pulverizing the Intermediate of the Aggregate Particles K1)

The particle size of the intermediate of the aggregate particles K1 produced is larger than that of the aggregate particles K1. The intermediate of the aggregate particles K1 are then pulverized, to produce aggregate particles K1 having a maximum particle size in the range of 1 to 500 μm (step S04 of FIGS. 10 and 11). The maximum particle size indicates the largest diameter of the aggregate particles K1 as observed in cross section.

### (Other Manufacturing Methods)

The aggregate particles K1 can also be produced by a spray drying method or the like, in which a liquid or a mixture of a liquid and a solid is sprayed into a gas and rapidly dried to produce a dry powder.

The aggregate particles K1 can be produced by the above-mentioned electrofusion method or sintering method irrespective of whether the metal oxide constituting the material for the aggregate particles is alumina, silica, titania, calcia, etc. The aggregate particles K1 that are produced are used to form the porous protective layer 37 by a thermal spraying method, a slurry coating method, or the like.

### (Thermal Spraying Method of Forming the Porous Protective Layer 37)

The aggregate particles K1 constituting the porous protective layer 37 of this embodiment are bonded to each other without the intervention of an inorganic binder B, as illustrated in FIG. 3. The porous protective layer 37 can be formed by making aggregate particles K1 adhere to the solid electrolyte body 31A by a thermal spraying method. When the porous protective layer 37 is formed by the thermal spraying method, then after sintering of the solid electrolyte body 31A, aggregate particles K1 whose surface is slightly molten are sprayed at high speed and in a high energy state, by plasma spraying or the like, onto the outer surface 301 of the solid electrolyte body 31A, to become stuck thereon. The porous protective layer 37 is thereby bonded without the intervention of an inorganic binder B.

In the aggregate particles K1 constituting the porous protective layer 37 formed by the thermal spraying method, the strength of the joint portions between the aggregate particles K1 is equal to the internal strength of the aggregate particles K1. In the porous protective layer 37 formed by the thermal spraying method, the crystal grain boundaries R between the crystal grains K2 constituting the aggregate particles K1 are portions that have low strength against stress such as thermal shock. Thus, when stress such as thermal shock is applied to a porous protective layer 37 formed by the thermal spraying method, cracks or the like are liable to occur at the crystal grain boundaries R between the aggregate particles K1.

In addition to the plasma spraying method of spraying the aggregate particles K1 on the solid electrolyte 31A, thermal spraying methods of spraying the aggregate particles K1 on the solid electrolyte body 31A also include frame spraying, cold spraying, etc.

### (Slurry Coating Method of Forming the Porous Protective Layer 37)

The aggregate particles K1 constituting the porous protective layer 37 may be bonded to each other via an inorganic binder B, as illustrated in FIG. 12. An inorganic binder B is mainly used when forming the porous protective layer 37 by the slurry coating method. When the porous protective layer 37 is formed by the slurry coating method, in which the slurry containing a mixture of aggregate particles K1 and the inorganic binder B, the slurry is made to adhere to the outer surface 301 of the solid electrolyte body 31A by methods such as dipping (immersing) in the slurry, or spraying the slurry. The slurry adhering to the solid electrolyte body 31A is then sintered, bonding the slurry to the outer surface 301 of the solid electrolyte body 31A and so forming the porous protective layer 37.

When sintering the slurry, it is necessary to prevent the characteristics of the sensor element 2A from being changed by heat. The slurry is therefore preferably sintered at a relatively low temperature, in the range of 500 to 1000° C. Furthermore, a material that becomes sintered at a relatively low temperature is often selected as the inorganic binder B. As a result, when stress such as thermal shock is applied to a porous protective layer 37 formed by the slurry coating method, a situation arises in which cracks or the like are liable to occur not in the aggregate particles K1, but in the inorganic binder B.

However, as various techniques for improving the strength of the inorganic binder B have been developed, it can be assumed that cracks or the like may arise in the aggregate particles K1 if the strength of the inorganic binder B is high. One technique for improving the strength of the inorganic binder B, for example, is disclosed in JP 2014-178179 A. The higher the strength of the bonding that is provided by the inorganic binder B between aggregate particles K1, the greater becomes the possibility of cracking in the crystal grains K2 constituting the aggregate particles K1.

In addition to the thermal spraying method and the slurry coating method, the porous protective layer 37 can also be formed by CVD (chemical vapor deposition), an aerosol deposition method, etc. However, from the aspects of material yield, takt time (work time), etc., it is preferable to use the thermal spraying method or the slurry coating method.

### (Method of Manufacturing Sensor Element 2A)

When manufacturing the sensor element 2A, a bottomed cylindrical solid electrolyte body 31A is prepared and plated to form a reference electrode 312 on the inner surface 302 of the solid electrolyte body 31A, while also forming a detection electrode 311 on the outer surface 301 of the solid electrolyte body 31A. The solid electrolyte body 31A, with the detection electrode 311 and the reference electrode 312 thereon, is then fired, to form the sensor element 2A. Next, the aggregate particles K1 are sprayed by a thermal spraying method onto the outer surface 301 of the formed sensor element 2A, including the detection electrode 311, to form the porous protective layer 37.

Alternatively, the slurry coating method may be used instead of the thermal spraying method. In that case, the aggregate particles K1 and the inorganic binder B are made to adhere to the outer surface 301 of the sensor element 2A including the detection electrode 311 to form the porous protective layer 37, and the porous protective layer 37 is fired.

### (Action and Effects)

With the exhaust sensor 1 of this embodiment, the porous protective layer 37 provided on the sensor element 2A is observed from a microscopic viewpoint, and measures are taken to increase the strength of the aggregate particles K1 constituting the porous protective layer 37. Specifically, focusing attention on the states of the plurality of crystal grains K2 constituting the aggregate particles K1, the number of crystal grain boundary intersections X where three or more crystal grains K2 intersect in an aggregate particle K1, per unit area, is made to be within the range of 1 to 10,000/μm².

As a result, the number of crystal grain boundary intersections X in the aggregate particles K1 is appropriate, so that when stress such as thermal shock is applied to the aggregate particles K1, the energy of the stress can be effectively dispersed. The strength of the aggregate particles K1 constituting the porous protective layer 37 can thereby be increased, and as a result, the water resistance of the porous protective layer 37 can be improved.

Hence, the exhaust sensor 1 of this embodiment enables the water resistance of the porous protective layer 37 to be improved.

In the aggregate particles K1, crystal grain boundary intersections X are formed in three dimensions. Hence it could be considered that the crystal grain boundary intersections X should be obtained as a number per unit volume. However, the crystal grain boundary intersections X are observed in cross section, and so are obtained as a number per unit area.

### Second Embodiment

In the exhaust sensor 1 of this embodiment, the solid electrolyte body 31B is plate-shaped and the sensor element 2B is of laminated type.

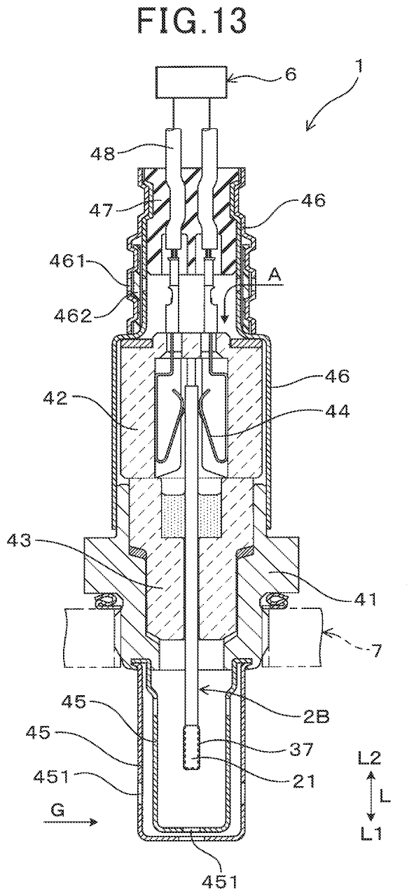

As shown in FIGS. 13 to 15, the solid electrolyte body 31B is conductive to oxygen ions (O²⁻) when at a predetermined activation temperature. The detection electrode 311 of the present embodiment is provided on a first surface 303 of the solid electrolyte body 31B, exposed to the gas G to be detected, and the reference electrode 312 is provided on a second surface 304 which is located on the opposite side of the solid electrolyte body 31B from the first surface 303 and is exposed to atmospheric air A. The detection electrode 311 and the reference electrode 312 face each other via the solid electrolyte body 31B on a portion of the sensor element 2B which is at the tip end L1 in the longitudinal direction L.

### (Gas Chamber 35)

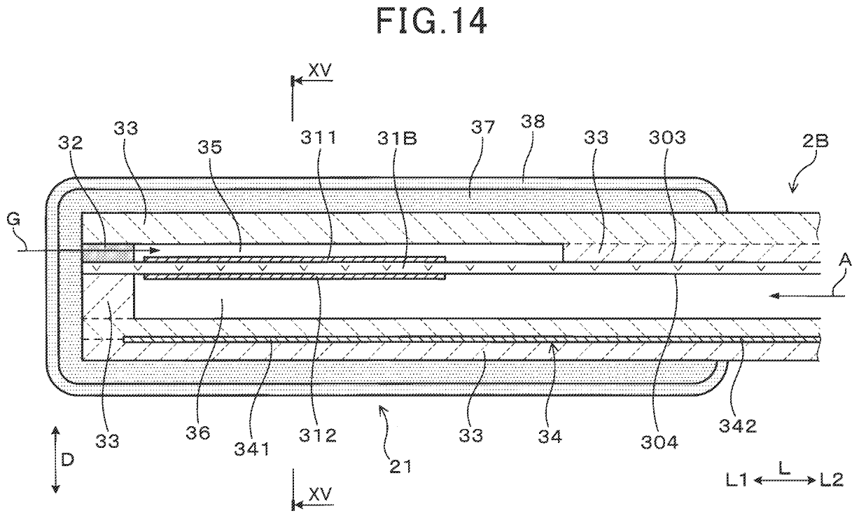

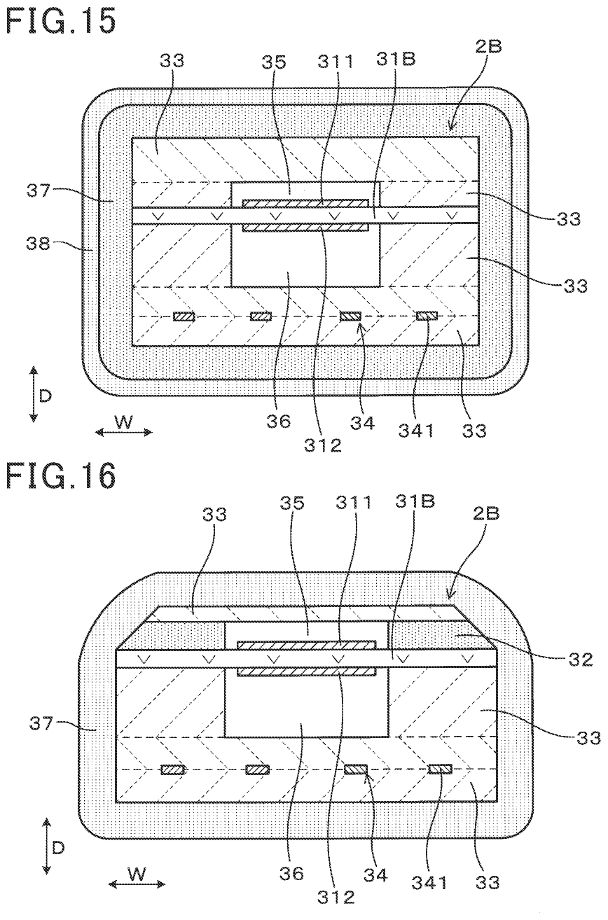

As shown in FIGS. 14 and 15, the sensor element 2B of the present embodiment has a gas chamber 35 into which the gas G to be detected is introduced. The gas chamber 35 is formed adjacent to the first surface 303 of the solid electrolyte body 31B and is surrounded by an insulator 33 and the solid electrolyte body 31B. The gas chamber 35 is formed at a position in the insulator 33 where the detection electrode 311 is accommodated. The gas chamber 35 is formed as a space that is enclosed by the insulator 33, a diffusion resistance portion 32, and the solid electrolyte body 31B. The gas G to be detected, which is the exhaust gas flowing in the exhaust pipe 7, is introduced into the gas chamber 35 by passing through the diffusion resistance portion 32.

### (Diffusion Resistance Portion 32)

As shown in FIG. 14, the diffusion resistance portion 32 of this embodiment is formed adjacent to the tip end L1 of the gas chamber 35, in the longitudinal direction L. The diffusion resistance portion 32 is disposed in an intake port of the insulator 33 which opens near the tip end L1 of the gas chamber 35, in the longitudinal direction L. The diffusion resistance portion 32 is formed of a porous metal oxide such as alumina. The diffusion rate (flow rate) at which the gas G to be detected is introduced into the gas chamber 35 is determined by the limited rate at which the gas G to be detected permeates through the pores in the diffusion resistance portion 32.

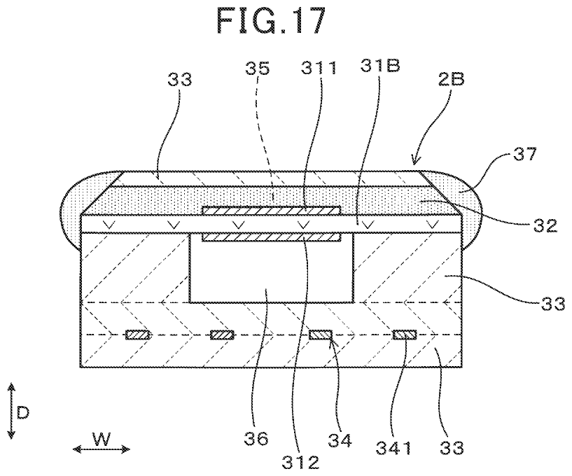

As shown in FIG. 16, the diffusion resistance portion 32 may be formed adjacent to both sides of the gas chamber 35, in the width direction W. In that case, diffusion resistance portions 32 are disposed in entry ports of the insulator 33 that open on respective sides of the gas chamber, 35 in the width direction W. The diffusion resistance portion 32 can be formed using a porous body consisting of a metal oxide such as alumina, or using pinholes consisting of small through holes that communicate with the gas chamber 35. As a further alternative, as shown in FIG. 17, the diffusion resistance portion 32 can be disposed such as to fill the interior of the gas chamber 35.

### (Porous Protective Layer 37)

As shown in FIGS. 14 and 15, the porous protective layer 37 is provided on the surface of the sensor element 2B including the intake port of the gas chamber 35. The intake port of the gas chamber 35, in the surface of the sensor element 2B, constitutes a path that guides the gas G to be detected to the surface of the detection electrode 311. Furthermore, the diffusion resistance portion 32 and the gas chamber 35 constitute a path that guides the gas G to be detected to the surface of the detection electrode 311.

The porous protective layer 37 of this embodiment is provided over the entire part of the sensor element 2B at the tip end L1, in the longitudinal direction L. The surface of the diffusion resistance portion 32 is covered with the porous protective layer 37. However as shown in FIG. 17, it would be equally possible for the porous protective layer 37 to be provided only around the intake port (the surface of the diffusion resistance portion 32) of the gas chamber 35 in the sensor element 2B. Another porous protective layer 38, using conventional aggregate particles having a number of crystal grain boundary intersections X per unit area of less than 1/μm², may be provided on the surface of the porous protective layer 37. Alternatively, the other porous protective layer 38 may be provided on the surface of the sensor element 2B, and the porous protective layer 37 provided on the surface of that other porous protective layer 38.

The porosity of the porous protective layer 37 is greater than the porosity of the diffusion resistance portion 32. The flow rate at which the gas G to be detected can permeate the porous protective layer 37 is higher than the flow rate at which the gas G to be detected can permeate the diffusion resistance portion 32.

### (Reference Gas Duct 36)

As shown in FIGS. 14 and 15, a reference gas duct 36 surrounded by the insulator 33 and the solid electrolyte body 31B is formed adjacent to the second surface 304 of the solid electrolyte body 31B. The reference gas duct 36 is formed such as to extend in the insulator 33, in the longitudinal direction L, from the position where the reference electrode 312 is housed to the end part of the sensor element 2B at the base end L2. The reference gas duct 36 is formed from the end part at the base end L2 to a position facing the gas chamber 35 via the solid electrolyte body 31B. Atmospheric air A is introduced into the reference gas duct 36 from the end part at the base end L2.

### (Heating Element 34)

As shown in FIGS. 14 and 15, a heating element 34 is embedded in the insulator 33 and has a heat generating portion 341 that generates heat by energization and a lead portion 342 that is connected to the heat generating portion 341. The heat generating portion 341 is disposed at a position where at least a part thereof overlaps the detection electrode 311 and the reference electrode 312 in the stacking direction D of the solid electrolyte body 31B and the insulator 33. The heat generating portion 341 is formed by a linear conductor portion, having a meandering configuration with straight portions and curved portions. The lead portion 342 extends in the longitudinal direction L to the end part of the sensor element 2B at the base end L2. The heating element 34 contains a conductive metal material.

### (Insulator 33)

The insulator 33 is formed using an insulating metal oxide such as alumina. The insulator 33 is laminated on the solid electrolyte body 31B to constitute the gas chamber 35, the reference gas duct 36, the diffusion resistance portion 32, etc.

### (Exhaust Sensor)

In the exhaust sensor 1 of this embodiment, as shown in FIG. 13, the sensor element 2B is retained in the housing 41 via another insulator 43. In other respects, the configuration is the same as for the exhaust sensor 1 of the first embodiment.

### (Method of Manufacturing Sensor Element 2B)

When manufacturing the sensor element 2B, a sheet constituting the solid electrolyte body 31B, a sheet constituting the insulator 33, etc., are successively laminated and made to adhere to each other via layers of an adhesive material. In addition, a paste material constituting the pair of electrodes 311, 312 is printed (coated) on the sheet constituting the solid electrolyte body 31B, and a paste material constituting the heating element 34 is printed (coated) on the sheet constituting the insulator 33. The intermediate bodies of the sensor element 2B, constituted by the respective sheets and paste material, are then fired at a predetermined firing temperature, to form the sensor element 2B. The aggregate particles K1 are then sprayed on the surface of the formed sensor element 2B by a thermal spraying method, to form the porous protective layer 37. Alternatively, a slurry coating method may be used instead of the thermal spraying method.

### (Action and Effects)

In the exhaust sensor 1 using the sensor element 2B of the present embodiment also, the water resistance of the porous protective layer 37 is improved by forming the protective layer using aggregate particles K1 in which the number of crystal grain boundary intersections X per unit area is in the range of 1 to 10,000/μm².

Other configurations, actions and effects etc., of the exhaust sensor 1 of this embodiment are the same as those of the first embodiment. Furthermore, in this embodiment also, components indicated by the same reference signs as those shown for the first embodiment are the same as those in the first embodiment.

The present disclosure is not limited to the respective embodiments, and it would be possible to configure different embodiments without departing from the gist of the disclosure. In addition, the scope of the present disclosure includes various modifications, modifications within a range of equivalents, and the like. Furthermore, the technical concepts of the present disclosure also include combinations, forms, etc., of various components that can be assumed from the present disclosure.

What is claimed is:

1. An exhaust sensor equipped with a sensor element and performing gas detection using the exhaust gas of an internal combustion engine as the gas to be detected, with the sensor element comprising a solid electrolyte body, a detection electrode provided on the solid electrolyte body and exposed to the gas to be detected, and a reference electrode provided on the solid electrolyte body, wherein:
a porous protective layer is provided on at least one surface of the detection electrode and a path for guiding the gas to be detected to the surface of the detection electrode;
the porous protective layer is composed of a plurality of aggregate particles bonded directly or via an inorganic binder; and,
when a plurality of crystal grains constituting aggregate particles are observed in cross section, the number of crystal grain boundary intersections at which three or more of the crystal grains intersect, per unit area, is in the range of 1 to 10,000/μm².

2. The exhaust sensor according to claim 1, wherein the aggregate particles comprise a metal oxide having a standard reaction Gibbs energy lower than that of an oxide of carbon.

3. The exhaust sensor according to claim 2, wherein the metal oxide includes at least one of aluminium oxide and magnesium oxide.

4. The exhaust sensor according to claim 1, wherein
the solid electrolyte body has a bottomed cylindrical shape;
the detection electrode is provided on an outer surface of the solid electrolyte body, exposed to the gas to be detected, and the reference electrode is provided on an inner surface of the solid electrolyte body; and,
the porous protective layer is provided on an outer surface of the solid electrolyte body including the surface of the detection electrode.

5. The exhaust sensor according to claim 1, wherein
the solid electrolyte body has a plate-like shape;
the sensor element has a gas chamber into which the gas to be detected is introduced;
the detection electrode is provided on a first surface of the solid electrolyte body, which is disposed within the gas chamber and is exposed to the gas to be detected, and the reference electrode is provided on a second surface of the solid electrolyte body, opposite to the first surface; and,
the porous protective layer is provided on a surface of the sensor element that includes the surface of an intake port of the gas chamber.
